(19) United States
(12) Patent Application Publication
(10) Pub. No.: US 2020/0042854 A1
(43) Pub. Date: Feb. 6, 2020

(54) Magnetic Identification Tag Holder

(71) Applicant: Victor Rey Salinas, Houston, TX (US)

(72) Inventor: Victor Rey Salinas, Houston, TX (US)

(21) Appl. No.: 16/054,794

(22) Filed: Aug. 3, 2018

(51) Int. Cl. G06K 19/077; H01F 7/02

(52) U.S. Cl. CPC G06K 19/07758; H01F 7/02

(57) ABSTRACT

A novel identification tag holder for holding an identification tag is disclosed, with a releasable magnetically connectible first and second portion, an identification tag, a retaining means to secure the tag, and a means for connecting it to a keyring to permit the user to securely carry the identification tag.

### FIELD OF INVENTION

The invention relates to magnetic holders, specifically, a detachable, magnetic identification tag holder.

### SUMMARY OF INVENTION

The present invention describes in the preferred embodiment a flexible identification tag holder with a first portion and second portion releasably joined by magnetic force. A flexible identification tag can be releasably held in place by the holder when the portions are joined. The holder can further be attached to a chain having a keyring disposed at the other end. When the portions are detached, the plug portion containing the magnet can be used to affix a flexible identification tag to a magnetically active surface, such as the typical refrigerator door.

It is an object of the invention to provide a novel, and useful magnetic holder to releasably hold a flexible identification tag that makes the tag easy to carry on one's person, and readily accessible for use.

Another object of the invention is to provide a magnetic holder that can releasably hold a flexible identification tag while attached to another surface made of ferromagnetic material or other magnetic surface for convenient access and to prevent misplacement of the flexible tag.

It is another object of the invention to have a non-magnetic portion of the magnetic holder that can be customized in material, shape, and color, and to bear a design, such as a logo, team name, or a message.

### BRIEF DESCRIPTION OF DRAWINGS

FIG. 1 is a diagram of an embodiment of the present invention showing the two parts of the holder joined together.

FIG. 2 is a diagram of an embodiment of the present invention showing the two parts of the holder separated.

FIG. 3a is a view of the exterior of the socket portion of the holder.

FIG. 3b is a side view of the socket portion of the holder showing the retainer with an inner socket with a magnetically active interior section.

FIG. 3c is the interior view of the socket portion showing the retainer and the socket.

FIG. 4a is an interior view of the plug portion showing the retainer and a plug.

FIG. 4b is a side view of the plug portion showing the retainer and the plug containing a magnet.

FIG. 4c is a view of the exterior portion of the holder.

FIG. 5 is a view of one embodiment of the exterior portion of the holder.

FIG. 6 is a view of the identification tag.

FIG. 7 is an exploded view of the holder and identification tag therewith.

### DETAILED DESCRIPTION OF THE DRAWINGS

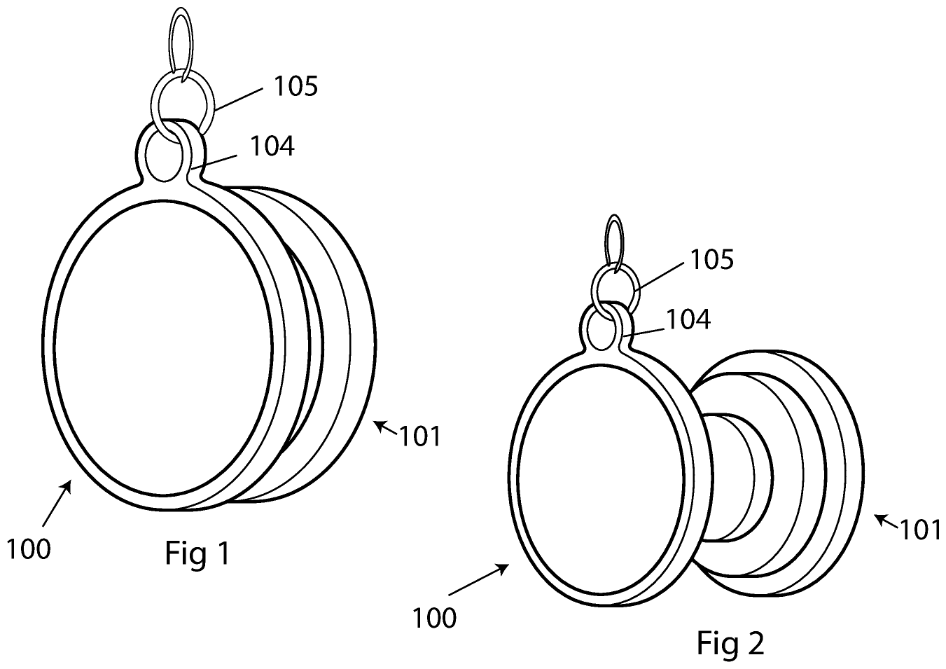

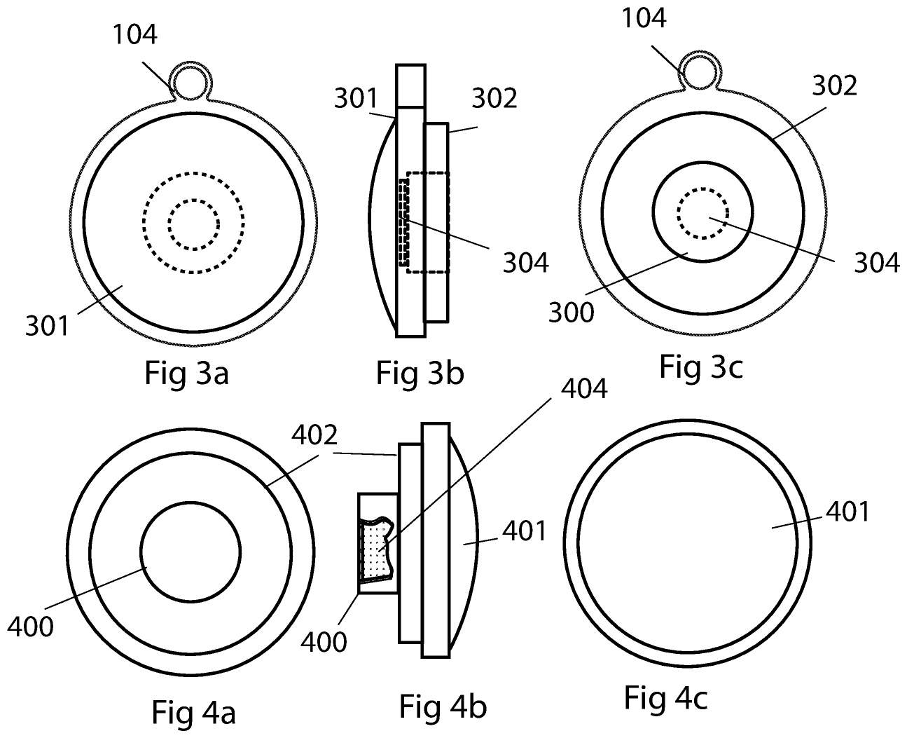

The invention is described as set forth in FIG. 1-7. Referring to FIG. 1 and FIG. 2, the holder comprises a socket portion 100 and plug portion 101 that can be releasably joined together through magnetic force as shown in FIG. 1, and then separated at shown in FIG. 2. The material used to construct the detachable portions can be metal, plastic, wood, rubber or synthetic rubber. As shown in FIGS. 3b, 3c, 4a, and 4b, within the edges of each portion, a protruding, substantially cylindrically shaped retainer 302 and 402 having a substantially planar surface is provided on the interior side of each portion wherein said retainers are of a matching circumference to each other. The retainer can be formed in conjunction with and as part of the portion or can be a separately constructed disc with a first substantially planar surface and a second substantially planar surface that is permanently attached on one planar surface to the interior surface of each portion. A hole 104 can be disposed along the outer edge of the exterior one portion to where a jump ring 105 can be attached to the hole 104 to permit the holder to be attached to a chain and keyring as part of a keychain.

The exterior side 301 of the socket portion as shown in FIG. 3a and FIG. 3b, and exterior side 401 of the plug portion as shown in FIG. 4b and FIG. 4c can be customized with a design, drawing, message, or textured surface. As shown in the side view FIG. 3b, a disc 304 made of a ferromagnetic metal is disposed within a socket 300 located substantially central of the retainer 302. The dimensions of the socket and the dimensions of the plug are such that the plug will seat securely into the socket.

A plug 400 is disposed on the interior center of the plug portion 101 as shown in FIG. 4a. Disposed within the plug 400 is a magnet 404. The magnet is preferably a rare earth magnet. The plug 400 containing a magnet 404 will magnetically engage the magnetically active ferromagnetic metal disc 304, keeping the two portions together until sufficient force is applied to separate the two portions.

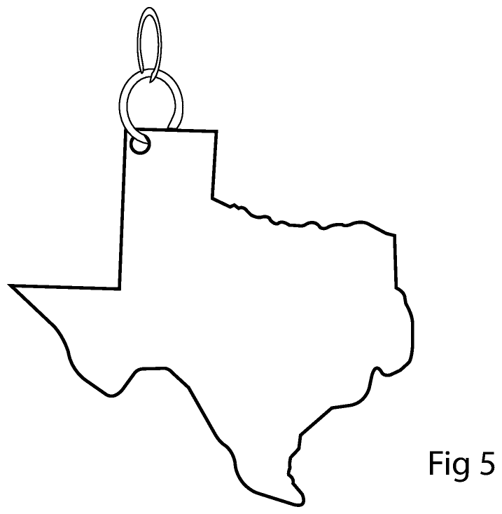

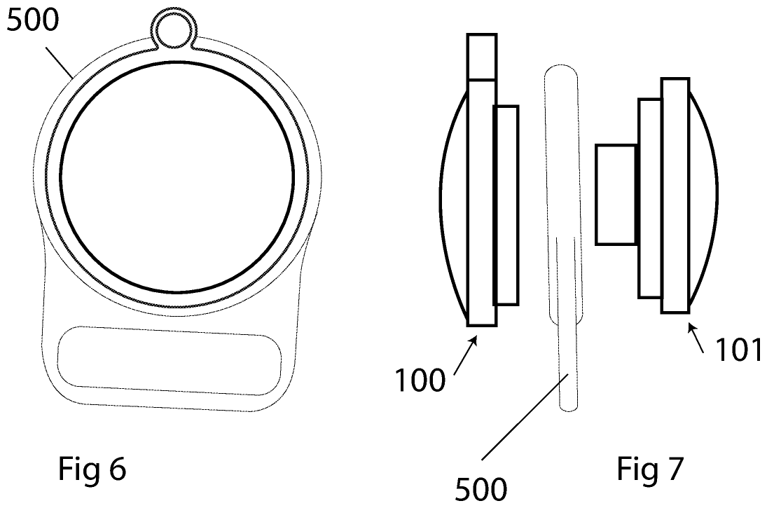

FIG. 5 depicts an alternate embodiment of the exterior side of the device. It can be formed in a variety of shape outlines. In FIG. 6, an identification tag 500 having a circular interior opening of a circumference compatible with the retainer can be held by the retainer on either portion of the holder prior to closing the two portions 100 and 101 together as shown in FIG. 7, keeping the identification tag secure.

1. An apparatus for holding an identification tag comprising:
a substantially flat plug portion having an exterior side and an interior side,
said plug portion exterior side having a substantially planar surface;
said plug portion interior side having a substantially cylindrical retainer projecting from tire interior side terminating with a substantially planar surface, and further having a plug disposed substantially centrally on the planar surface of the retainer, and a permanent magnet located within the plug; and
a substantially flat socket portion having an exterior side and an interior side,
said socket portion exterior side having a substantially planar surface;
said socket portion interior side having a substantially cylindrical retainer projecting from the interior side terminating with a substantially planar surface, and further having a recessed socket substantially centrally located on the surface having dimensions to securely seat the plug, and a magnetically active disc located thereunder the socket; and
wherein said plug portion and socket portion can be magnetically joined by inserting the plug into the socket.

2. (canceled)

3. The apparatus of claim 1 wherein a jump ring is attached to one or more portions of the apparatus.

4. (canceled)

5. An apparatus for holding an identification tag comprising:
a substantially flat disc having a first side and a second side,
said first side having a substantially planar surface;
said second side having a substantially planar surface with a cylindrical retainer projecting therewith from the surface, terminating with a substantially planar surface.

6. The apparatus of claim 5 further comprising a permanent magnet disposed substantially centrally on the planar surface of the cylindrical retainer.
